(19) United States
(12) Patent Application Publication
(10) Pub. No.: US 2026/0067226 A1
(43) Pub. Date: Mar. 5, 2026

(54) ENHANCEMENTS FOR LOW LATENCY SUPPORT IN NEXT GENERATION WLANS

(71) Applicant: Samsung Electronics Co., Ltd., Suwon-si (KR)

(72) Inventors: Peshal Nayak, Plano, TX (US); Bilal Sadiq, Plano, TX (US); Boon Loong Ng, Plano, TX (US); Yue Qi, Plano, TX (US); Rubayet Shafin, Frisco, TX (US); Vishnu Vardhan Ratnam, Frisco, TX (US)

(21) Appl. No.: 19/315,382

(22) Filed: Aug. 29, 2025

Related U.S. Application Data
(60) Provisional application No. 63/690,914, filed on Sep. 5, 2024.
(60) Provisional application No. 63/695,638, filed on Sep. 17, 2024.
(60) Provisional application No. 63/695,660, filed on Sep. 17, 2024.

(51) Int. Cl. H04L 47/2441; H04W 28/02; H04W 84/12

(52) U.S. Cl. CPC H04L 47/2441; H04W 28/0268; H04W 84/12

(57) ABSTRACT

A station (STA) includes a processor. The processor is configured to identify a traffic condition for the STA, and generate a message based on the traffic condition for the STA. The STA also includes a transceiver operably coupled to the processor. The transceiver is configured to transmit, to an access point (AP), the message based on the traffic condition for the STA, and receive, from the AP, according to a triggering pattern, a trigger to transmit one or more packets.

### CROSS-REFERENCE TO RELATED APPLICATION(S) AND CLAIM OF PRIORITY

This application claims priority under 35 U.S.C. § 119(e) to U.S. Provisional Patent Application No. 63/690,914 filed on Sep. 5, 2024, U.S. Provisional Patent Application No. 63/695,638 filed on Sep. 17, 2024, and U.S. Provisional Patent Application No. 63/695,660 filed on Sep. 17, 2024. The above-identified provisional patent applications are hereby incorporated by reference in their entirety.

### TECHNICAL FIELD

This disclosure relates generally to wireless networks. More specifically, this disclosure relates to enhancements for low latency support in next generation wireless local area networks (WLANs).

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for enhancements for low latency support in next generation WLANs.

In one embodiment, a station (STA) is provided. The STA includes a processor. The processor is configured to identify a traffic condition for the STA, and generate a message based on the traffic condition for the STA. The STA also includes a transceiver operably coupled to the processor. The transceiver is configured to transmit, to an access point (AP), the message based on the traffic condition for the STA, and receive, from the AP, according to a triggering pattern, a trigger to transmit one or more packets.

In another embodiment, an AP is provided. The AP includes a transceiver. The transceiver is configured to receive, from a STA, a message generated based on a traffic condition for the STA, the AP also includes a processor operably coupled to the transceiver. The processor is configured to adjust a triggering pattern based on the message generated based on the traffic condition for the STA, and cause the transceiver to transmit, according to the triggering pattern, one or more triggers to trigger the STA to transmit one or more packets.

In yet another embodiment, a method of operating a STA is provided. The method includes identifying a traffic condition for the STA, and generating a message based on the traffic condition for the STA. The method also includes (i) transmitting, to an AP, the message based on the traffic condition for the STA, and (ii) receiving, from the AP according to a triggering pattern, a trigger to transmit one or more packets.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE P802.11be/D4.0, 2023; and [2] IEEE Std 802.11-2020.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example SCS request frame format according to embodiments of the present disclosure;

FIG. 4 illustrates an example of BSR handing during SCS operation according to embodiments of the present disclosure;

FIG. 5 illustrates an example of grouping packets based on arrival and reporting according to embodiments of the present disclosure;

FIG. 6 illustrates an example of grouping information based on similarity in reporting information and reporting according to embodiments of the present disclosure;

FIG. 7 illustrates an example of reporting for the most urgent frame according to embodiments of the present disclosure;

FIG. 8 illustrates an example of reporting for the HOL packet according to embodiments of the present disclosure;

FIG. 9 illustrates an example of timing information sharing from the STA side according to embodiments of the present disclosure;

FIG. 10 illustrates an example of enhanced SCS operation according to embodiments of the present disclosure;

FIG. 11 illustrates an example of trigger pattern change with encoding bit rate based on timing information reporting according to embodiments of the present disclosure;

FIG. 12 illustrates an example of trigger pattern change with encoding bit rate based on missed packets according to embodiments of the present disclosure;

FIG. 13 illustrates an example of modification of trigger pattern by a STA according to embodiments of the present disclosure;

FIG. 14 illustrates another example of modification of trigger pattern by a STA according to embodiments of the present disclosure;

FIG. 15 illustrates an example method for enhancement for low latency support in next generation WLANs according to embodiments of the present disclosure; and

FIG. 16 illustrates another example method for enhancement for low latency support in next generation WLANs according to embodiments of the present disclosure.

### DETAILED DESCRIPTION

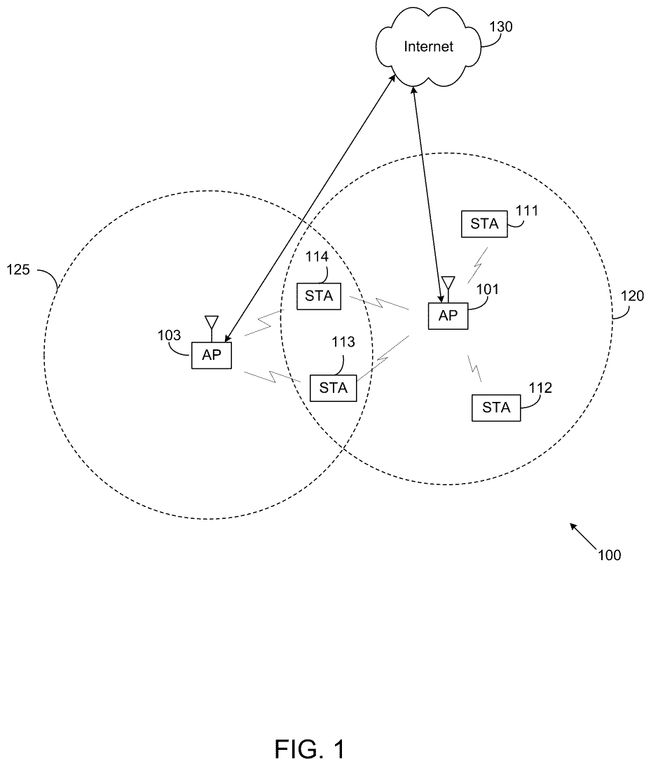

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

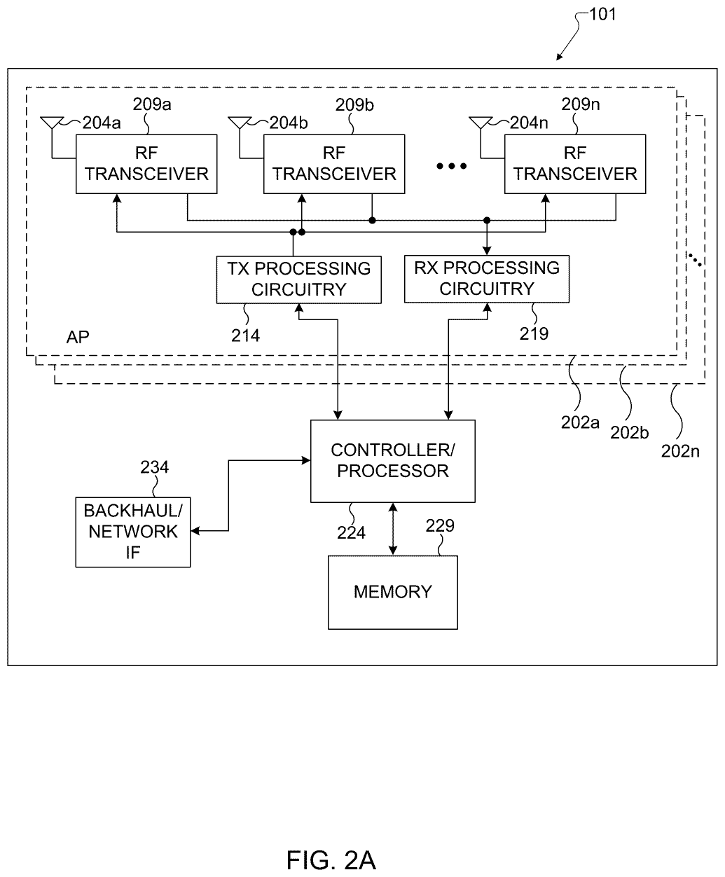

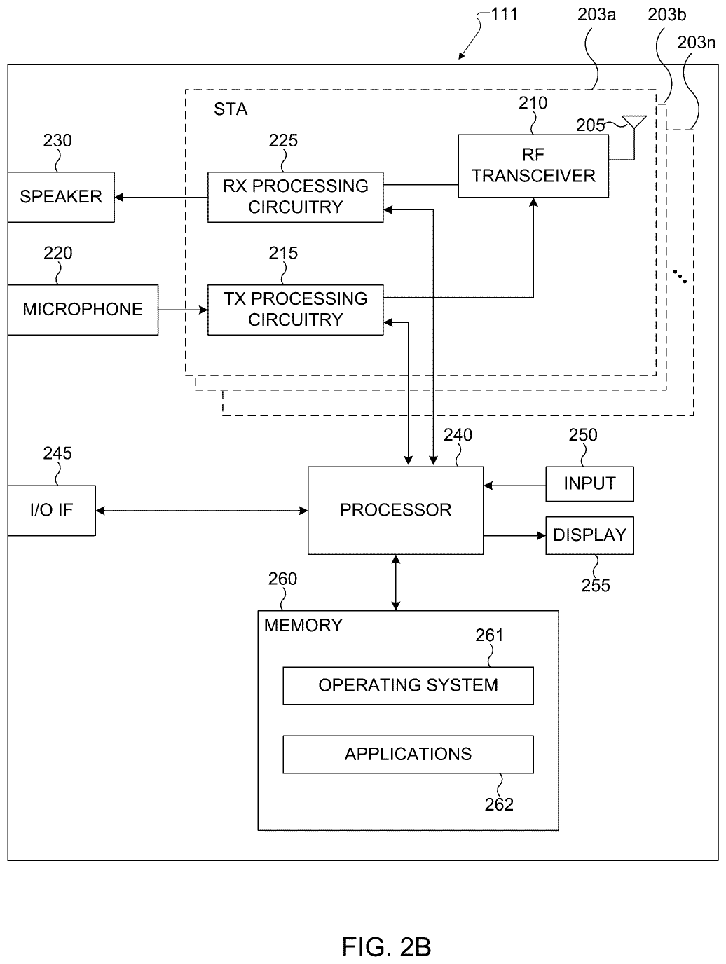

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUS). Also, while FIG. 2B illustrates the non-AP MLD 111 configured as a mobile telephone or smartphone, non-AP MLDs can be configured to operate as other types of mobile or stationary devices.

Current performance improvement objectives for WLANs include providing ultra-high reliability by reducing latencies to ultra-low values, increasing throughput at different signal-to-noise ratio (SNR) levels, enhancing power savings, etc. to better support new applications.

Some of the new applications that these improvement objectives seek to support are shown in Table 1 below. For each application category, Table 1 shows the requirements in terms of intra-basic service set (intra-BSS) latency (which is the time to transmit a frame from the AP to the STA or vice versa), the jitter variance, packet loss and data rate (Mbps).

TABLE 1
Example applications with ultra-low latency requirements

| | | Intra BSS | Jitter | | |
|---|---|---|---|---|---|
| | | latency | variance | | Data rate |
| Use cases | | (ms) | (ms) | Packet loss | (Mbps) |
| Real-time gaming | | <5 | <2 | <0.1% | <1 |
| Cloud gaming | | <10 | <2 | Near-lossless | <0.1 (Reverse link) |
| | | | | | >5 Mbps (Forward link) |
| Real-time video | | <3~10 | <1~2.5 | Near-lossless | 100 ~28,000 |
| Robotics | Equipment control | <1~10 | <0.2~2 | Near-lossless | <1 |
| and | Human safety | <1~10 | <0.2~2 | Near-lossless | <1 |
| industrial | Haptic technology | <1~5 | <0.2~2 | Lossless | <1 |
| automation | Drone | <100 | <10 | Lossless | <1 |
| | control | | | | >100 with video |

Existing WLANs support a number of frameworks for reporting traffic related information, including:
1. Buffer status report (BSR): A STA can transmit a buffer status report to the AP. The BSR can contain information on the amount of traffic that is queued at the STA side. The AP can use this information for performing a buffer based scheduling.
2. Stream classification service (SCS) setup: A STA can setup an SCS with the AP. The STA can provide a quality of service (QoS) characteristic information element in the SCS request frame to inform the AP about the traffic characteristics and QoS requirements of the flow. This approach is useful for quasi-static flows where the AP can approximate the flow as periodic and apply appropriate scheduling to meet the QoS requirements.

For scheduling purposes, one of the key pieces of information missing at the AP-side is the timing information from the STA side (e.g., enqueue/expiration time, head of line [HOL] delay). Based on existing signaling, the STA cannot provide that information to the AP. Feedback methods such as BSR do not carry a timing component. Often the STA side does not have information on the traffic pattern/arrival information ahead of time. As a result, the STA may not report this information in the STA's SCS setup. The AP also may not be able to predict this information on its own, as traffic at the STA can have a non-deterministic arrival pattern or can be event based.

Reporting timing information can be useful. Examples of reported timing information can be as shown in Table 2.

TABLE 2
Examples of reported timing information

| Example | |
|---|---|
| information | |
| item | Description |
| Enqueue/arrival | One or more information items that can describe |
| time | the enqueue/arrival time of the packet. |
| Enqueue | One or more information items that can describe |
| timestamp | the enqueue/arrival time coupled with a duration |
| coupled with | for which the packet can be considered as valid. |
| delay bound | |
| Time until | One or more information items that can indicate a |
| expiration | duration after which the packet can expire. |
| Expiration | One or more information items that can indicate a |
| timestamp | time at which the packet can expire. |
| Queuing delay | One or more information items that can indicate a |
| | duration for which the packet was in the queue. |

However, if the STA starts to explicitly report timing information for the enqueued packets, the reporting overhead can consume a lot of airtime and can affect the STA's performance. As a result, a reporting procedure which minimizes the overhead is desirable.

Various embodiments of the present disclosure provide mechanisms for minimal overhead for timing information reporting.

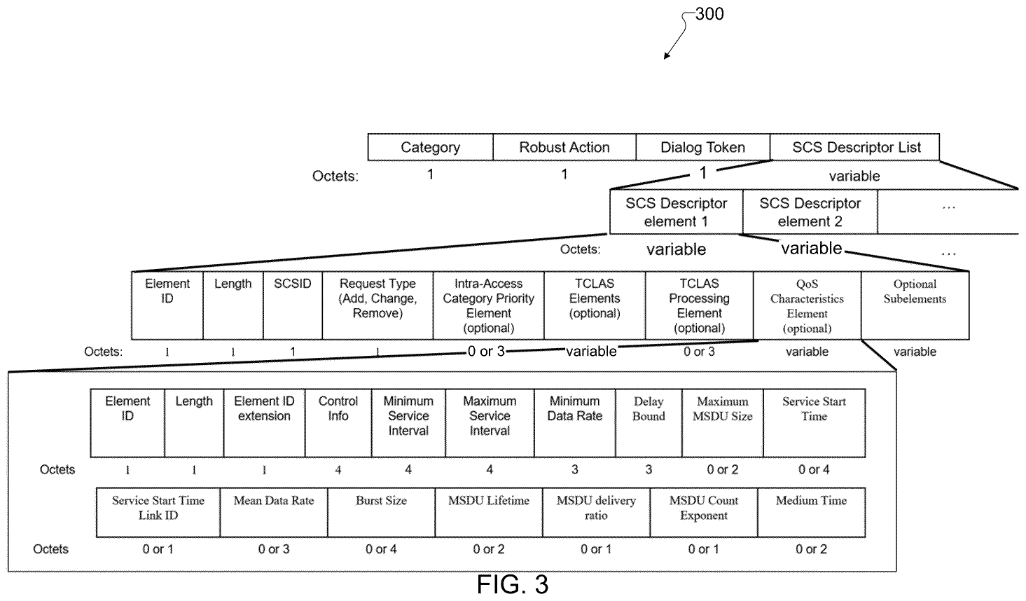

Existing WLANs support an SCS that can enable a STA to define scheduling requirements for its traffic. With SCS, the STA can request the AP to apply certain QoS treatment to its traffic flows. The STA can also provide a QoS characteristics element in its SCS request. The SCS request frame can have a format as shown in FIG. 3.

FIG. 3 illustrates an example SCS request frame format 300 according to embodiments of the present disclosure. The embodiment of an SCS request frame of FIG. 3 is for illustration only. Different embodiments of an SCS request frame format could be used without departing from the scope of this disclosure.

In the example of FIG. 3, the SCS request frame includes the following elements:
1. Intra-access category priority element: The intra-access category priority element can provide the information from a non-AP STA to an AP on the relative priorities of streams within an AC.
2. Traffic classification (TCLAS element): The TCLAS element contains a set of parameters necessary to identify various kinds of PDU or incoming MSDU (from a higher layer in all STAs or from the DS in an AP) that belong to a particular TS. The Frame Classifier field comprises the following subfields: Classifier Type, Classifier Mask, and Classifier Parameters.
3. TCLAS processing element: The TCLAS processing element is present when there are multiple TCLAS elements present in the descriptor. The TCLAS processing element provides information on how to handle the multiple TCLAS elements.
4. QoS characteristics element: The QoS characteristics element describes the QoS expectations of a flow.
5. Optional sub-elements

Although FIG. 3 illustrates one example SCS request frame format 300, various changes may be made to FIG. 3. For example, various changes to fields could be made, etc. according to particular needs.

Upon receiving an SCS request, the AP can process the request and respond with an SCS response.

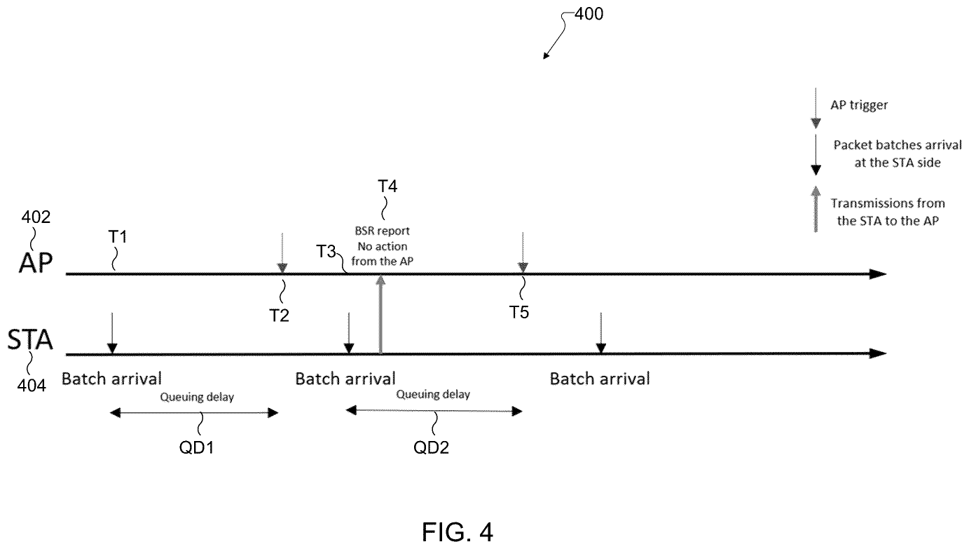

When an SCS agreement is setup with the AP, the traffic pattern reporting from the STA during the setup stage can reduce the need for a buffer status report (BSR) exchange. In some implementations, the BSR poll (BSRP)/BSR exchanges can be suppressed during the SCS operation and the BSRs reported in an unsolicited manner may not receive a response from the AP, similar as shown in FIG. 4. However, this can make the AP's scheduling oblivious to the instantaneous conditions at the STA side. In some applications, where the traffic pattern can be aperiodic/non-deterministic, this can result in some inefficiencies.

FIG. 4 illustrates an example of BSR handing during SCS operation 400 according to embodiments of the present disclosure. The embodiment of BSR handing during SCS operation of FIG. 4 is for illustration only. Different embodiments of BSR handing during SCS operation could be used without departing from the scope of this disclosure.

In the example of FIG. 4, a STA 404 receives a batch of packets at a time T1. STA 404 queues the packets for transmission until an AP 402 transmits a trigger at time T2. The difference between time T2 and T1 is the queuing delay (“QD1”). STA 404 receives another batch of packets at time T3, and transmits a BSR to AP 402 at time T4. AP 402 takes no action in response to the BSR. As a result, AP 402 maintains the same triggering pattern, and STA 404 queues the packets for transmission until AP 402 transmits a trigger at time T5, resulting in a substantially similar queuing delay QD2.

Although FIG. 4 illustrates one example of BSR handling during SCS operation 400, various changes may be made to FIG. 4. For example, various changes to queueing delays could be made, etc. according to particular needs.

Various embodiments of the present disclosure provide mechanisms for reduced queueing delay in SCS operation.

When a STA sets up an SCS with an AP, the STA can send a QoS characteristic information element (IE) which can contain information about the traffic characteristics of the application running on the STA side. For example, the STA can specify the minimum and the mean data rate of the application traffic when setting up the SCS. These parameters can enable the AP to estimate the triggering frequency for a given STA. However, as the user continues to use the application, these parameters can change depending on the user activity. For instance, the user may be running a video application and may have a lower bit rate generated by the video encoder when the camera is in a fixed position or the scene is static. As the user moves the camera or the scene is more dynamic, the video encoder can generate a higher bit rate. The bit rate can thus fluctuate depending on the movement of the camera, nature of the scene, etc. As the bit rate changes, the amount of backlog at the STA can also increase and this may benefit from a change to the triggering pattern of the AP (e.g., when the bit rate is more stable and low, the gap between the triggers from the AP can be higher compared to when the bit rate is higher which may need more frequent triggering, higher time allocation from each trigger, etc.).

Various embodiments of the present disclosure provide mechanisms for controlling AP triggering patterns from the STA side.

As noted above, various embodiments of the present disclosure provide mechanisms for minimal overhead for timing information reporting.

In some embodiments, a batch-based approach can be used for timing information reporting. In embodiments such as these, the timing information can be reported for a group of packets instead of reporting the timing information for each packet.

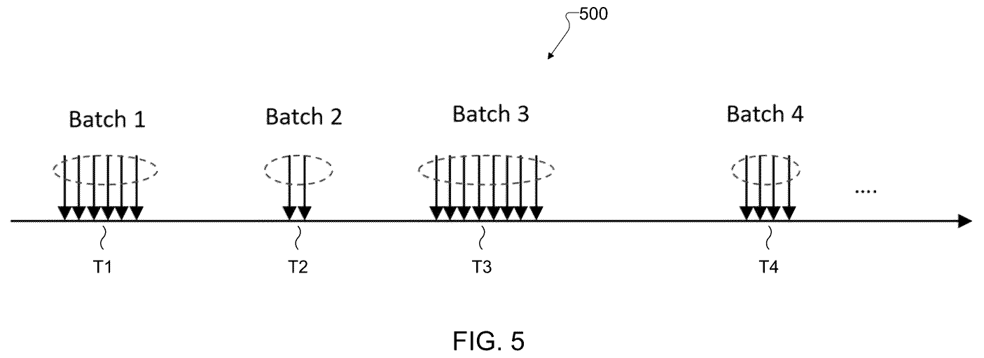

In some embodiments, timing information can be reported based on packet arrival, similar as shown in FIG. 5.

FIG. 5 illustrates an example of grouping packets based on arrival and reporting 500 according to embodiments of the present disclosure. The embodiment of grouping packets based on arrival and reporting of FIG. 5 is for illustration only. Different embodiments of grouping packets based on arrival and reporting could be used without departing from the scope of this disclosure.

In the example of FIG. 5, each of the arrows represents the arrival of a packet. As can be seen, several packets are arriving in a short time frames as “bursts” separated by periods with no packet arrivals. For example, near a time T1, five packets arrive closely spaced in time, and after a period of no packet arrivals, two more closely spaced packets arrive near time T2. Other bursts of packets arrive near time T3 (eight packets) and T4 (four packets). Each of these packet bursts can be grouped into a batch (e.g., Batch 1 for the packets arriving near time T1, Batch 2 for the packets arriving near time T2, etc.). Timing information can be reported for each batch instead of individually for each packet, as the information can be similar when these packets belong to the same traffic stream and traffic identifier (TID)/access category (AC).

Although FIG. 5 illustrates one example of grouping packets based on arrival and reporting 500, various changes may be made to FIG. 5. For example, various changes to the batches could be made, etc. according to particular needs.

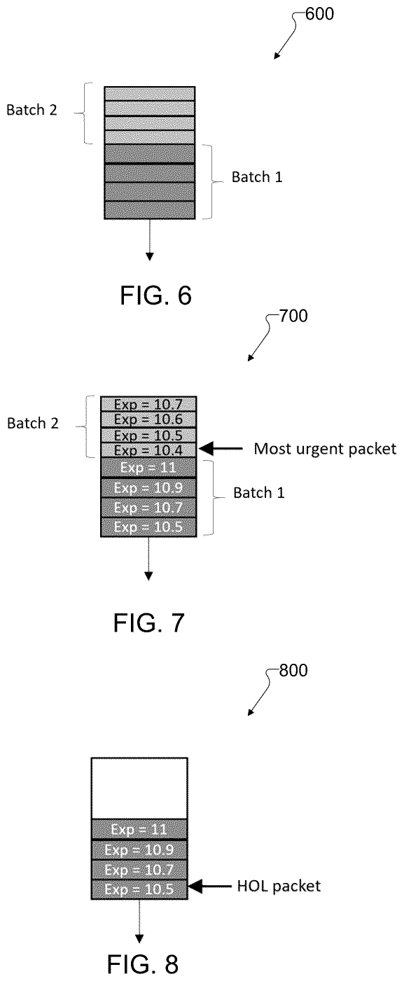

In some embodiments, timing information can be reported based on similarity in reporting information, similar as shown in FIG. 6.

FIG. 6 illustrates an example of grouping information based on similarity in reporting information and reporting 600 according to embodiments of the present disclosure. The embodiment of grouping information based on similarity in reporting information and reporting of FIG. 6 is for illustration only. Different embodiments of grouping information based on similarity in reporting information and reporting could be used without departing from the scope of this disclosure.

In the example of FIG. 6, a group of packets enqueued in the same AC queue are grouped based on their timing information. The packets marked as batch 1 have an expiration time around the same time, and the packets marked as batch 2 have an expiration time around the same time. However, the grouping can also occur across different access categories if the packets have a similar expiration time. Timing information can be reported for each batch instead of individually for each packet.

Although FIG. 6 illustrates one example of grouping information based on similarity in reporting information and reporting 600, various changes may be made to FIG. 6. For example, various changes to the batches could be made, etc. according to particular needs.

When performing grouping, a batch size can be reported. The batch size can be in terms of one or more of the information items as indicated in Table 3.

TABLE 3
Information items that can be used to convey batch size

| Information | |
|---|---|
| item | Description |
| Number of | One or more information items that can convey the |
| packets | number of packets in the batch (e.g., number of |
| | packets if they are of fixed/known size or the |
| | total number of 1KB segments). |
| Byte size | One or more information items that can convey the |
| | total byte size of the batch. |
| Compressed | One or more information items that can indicate the |
| count | total count in terms of a scaling factor (e.g., |
| indication | there can be an indication that provides |
| | information on the scaling factor in the signaling |
| | based on an encoding and the number of packets can |
| | be reported as an approximate/exact multiple of |
| | this scaling factor). |
| Compressed | One or more information items that can indicate the |
| byte size | total byte size in terms of a scaling factor. E.g., |
| indication | there can be an indication that provides information |
| | on the scaling factor in the signaling based on an |
| | encoding and the byte size can be reported as an |
| | approximate/exact multiple of this scaling factor. |

In some embodiments, timing information can be reported based on a most urgent frame, similar as shown in FIG. 7.

FIG. 7 illustrates an example of reporting for the most urgent frame 700 according to embodiments of the present disclosure. The embodiment of reporting for the most urgent frame of FIG. 7 is for illustration only. Different embodiments of reporting for the most urgent frame could be used without departing from the scope of this disclosure.

In the example of FIG. 7, a group of packets enqueued in the same AC queue are grouped based on their timing information. The packets marked as batch 1 have an expiration time around the same time, and the packets marked as batch 2 have an expiration time around the same time. When a batch is formed, the reporting can be for the most urgent packet in each batch along with a batch size. For example, the reporting for batch 2 can report the expiration of “10.4” and the batch size could be reported as “four packets”, while the reporting for batch 1 can report the expiration of “10.5” and the batch size could be reported as “four packets.” In another example, FIG. 7 could represent a single batch instead of batch 1 and batch 2, and the single batch could be reported with the expiration of “10.4” and a batch size of “eight packets.”

Although FIG. 7 illustrates one example of reporting for the most urgent frame 700, various changes may be made to FIG. 7. For example, various changes to the expiration times could be made, etc. according to particular needs.

In some embodiments, timing information can be reported based on a head of the line (HOL) packet, similar as shown in FIG. 8.

FIG. 8 illustrates an example of reporting for the HOL packet 800 according to embodiments of the present disclosure. The embodiment of reporting for the HOL packet of FIG. 8 is for illustration only. Different embodiments of reporting for the HOL packet could be used without departing from the scope of this disclosure.

In the example of FIG. 8, a group of packets enqueued in the same AC queue are grouped based on their timing information. The packets in the queue shown in FIG. 8 have an expiration time around the same time. When a batch is formed, the reporting can be for the head of the line packet in each batch along with a batch size. For example, for the batch shown in FIG. 7, the reporting would be the timestamp for HOL packet (shown with the expiration of “10.5”), and the batch size could be reported as “four packets.”

Although FIG. 8 illustrates one example of reporting for the HOL packet 800, various changes may be made to FIG. 8. For example, various changes to the expiration times could be made, etc. according to particular needs.

In some embodiments, timing information can be reported based on an average value of the expiration time of the batch. For example, in some embodiments an average value can be provided for the expiration time. When a batch is formed, the reporting can be of an average value that is average over a batch.

In some embodiments, timing information can be reported as select bits of the timing synchronization function (TSF) timer. For example, the timing information could report 7 bit (e.g., b16-b10) of the TSF timer.

As noted above, various embodiments of the present disclosure provide mechanisms for reduced queueing delay in SCS operation.

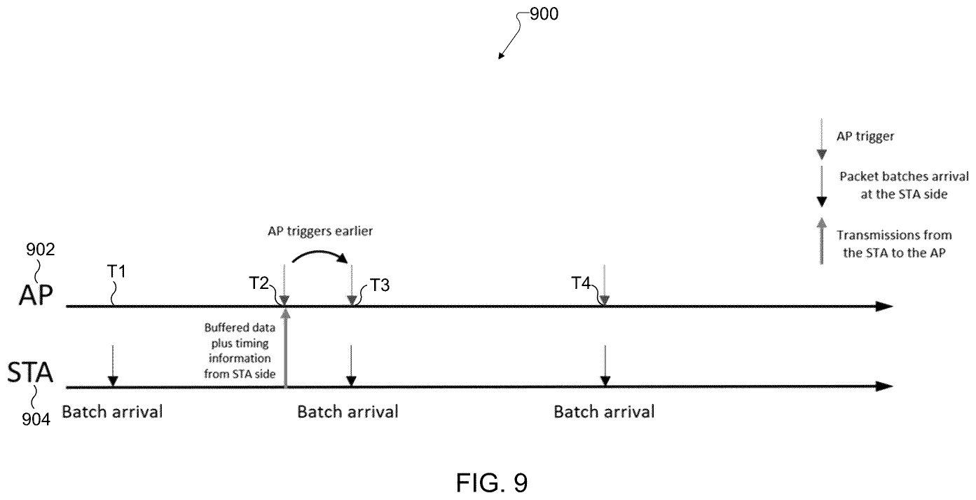

In some embodiments, the STA can provide timing information to the AP to enable the AP to change the scheduling based on the changing traffic conditions, similar as shown in FIG. 9. For example, the STA can provide expiration time, enqueue timing, HOL delay, queuing delay, etc. to the AP to enable the AP to make the change. The AP can then adjust its triggers to match the packet arrival pattern at the STA side.

FIG. 9 illustrates an example of timing information sharing from the STA side 900 according to embodiments of the present disclosure. The embodiment of timing information sharing from the STA side of FIG. 9 is for illustration only. Different embodiments of timing information sharing from the STA side could be used without departing from the scope of this disclosure.

In the example of FIG. 9, a STA 904 receives a batch of packets at a time T1. STA 904 queues the packets for transmission until an AP 402 transmits a trigger at time T2. After the trigger, STA 904 transmits its buffered data, and transmits timing information to AP 902. AP 902 adjusts its timing data to accommodate the packet arrival pattern of STA 904. STA 904 receives another batch of packets at time T3, which is immediately followed by AP 902 transmitting a trigger. Similarly, STA 904 receives another batch of packets at time T4, which is immediately followed by AP 902 transmitting a trigger.

Although FIG. 9 illustrates one example of timing information sharing from the STA side 900, various changes may be made to FIG. 9. For example, various changes to queueing delays could be made, etc. according to particular needs.

In some embodiments, an enhanced SCS operation can be used. As described herein, in enhanced SCS operation, the STA can transmit BSRs when needed and the AP can be required to respond to the BSRs and make changes in the APs scheduling pattern.

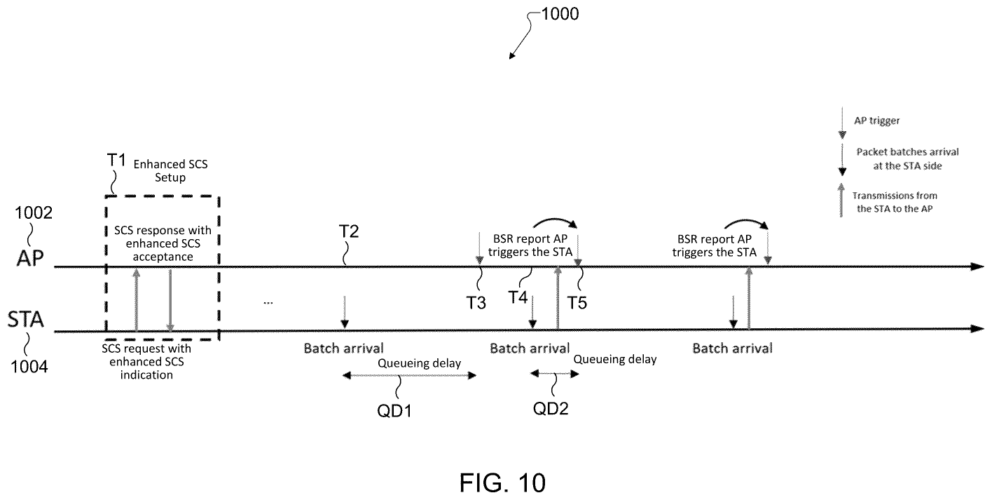

FIG. 10 illustrates an example of enhanced SCS operation 1000 according to embodiments of the present disclosure. The embodiment of enhanced SCS operation of FIG. 10 is for illustration only. Different embodiments enhanced SCS operation could be used without departing from the scope of this disclosure.

In the example of FIG. 10, near a time T1, an AP 1002 and a STA 1004 perform an enhanced SCS setup operation, which includes the STA 1004 transmitting an SC request with an enhanced SCS indication to the AP 1002. In response, the AP 1002 transmits an SCS response with enhanced SCS acceptance to STA.

STA 1004 receives a batch of packets at time T2. STA 1004 queues the packets for transmission until an AP 1002 transmits a trigger at time T3. The difference between time T3 and T2 is the queuing delay (“QD1”). STA 1004 receives another batch of packets at time T3, and shortly thereafter, STA 1004 transmit a BSR to AP 1002. In response to the BSR, AP 1002 transmits a trigger at time T5, resulting in a shorter queuing delay QD2 for the batch of packets that arrived at time T3.

Although FIG. 10 illustrates one example of enhanced SCS operation 1000, various changes may be made to FIG. 10. For example, various changes to queueing delays could be made, etc. according to particular needs.

As noted above, various embodiments of the present disclosure provide mechanisms for controlling AP triggering patterns from the STA side.

In some embodiments, the STA can transmit timing information to the AP (e.g., enqueue time, expiration time, HOL delay, etc.) for the enqueued backlog. The AP can use this information to understand the need for frequent triggering. As the time between the enqueue and the transmission of the packet(s) increases, the AP can increase the frequency of triggering. If the AP triggers the STA and the STA does not have any backlog to transmit, then the AP can reduce the frequency of triggering.

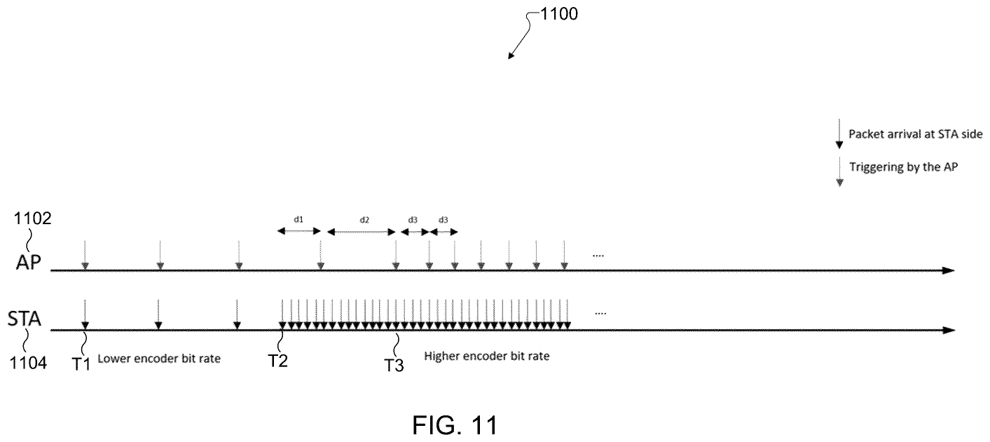

FIG. 11 illustrates an example of trigger pattern change with encoding bit rate based on timing information reporting 1100 according to embodiments of the present disclosure. The embodiment of trigger pattern change of FIG. 11 is for illustration only. Different embodiments of trigger pattern change with encoding bit rate based on timing information reporting could be used without departing from the scope of this disclosure.

In the example of FIG. 11, at time T1, STA 1104 begins receiving packets at a lower encoder bit rate, and the AP 1102 transmits triggers with a trigger pattern similar to the arrival time of the packets. At time T2, STA 1104 begins receiving packets at a higher encoder bit rate, and the AP 1102 continues to transmit triggers with the same triggering pattern, resulting in queuing delay d1 and d2. Prior to time T3, STA 1104 transmits timing information to AP 1102 (not shown), and AP 1104 increases the frequency of triggering, resulting in a shorter queuing delay d3.

Although FIG. 11 illustrates one example trigger pattern change with encoding bit rate based on timing information reporting 1100, various changes may be made to FIG. 11. For example, various changes to the trigger pattern could be made, etc. according to particular needs.

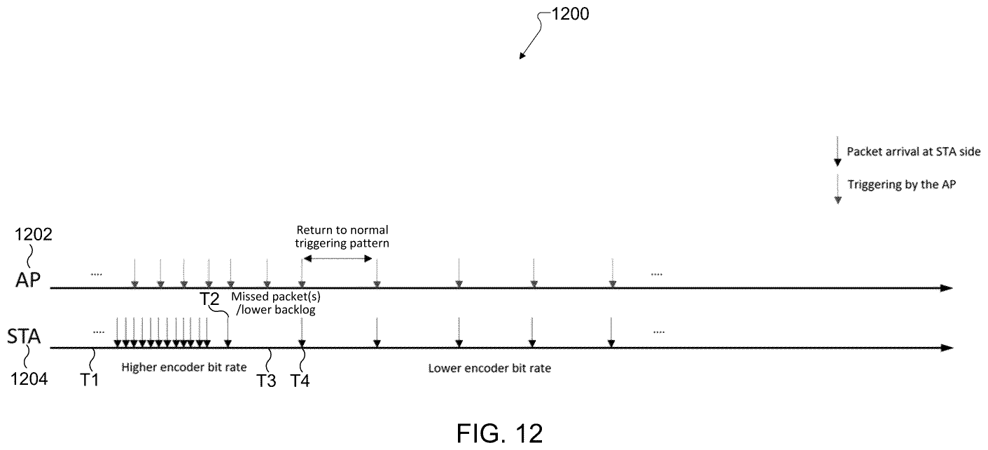

FIG. 12 illustrates an example of trigger pattern change with encoding bit rate based on missed packets 1200 according to embodiments of the present disclosure. The embodiment of trigger pattern change of FIG. 12 is for illustration only. Different embodiments of trigger pattern change with encoding bit rate based on missed packets could be used without departing from the scope of this disclosure.

In the example of FIG. 12, at time T1, STA 1204 begins receiving packets at a higher encoder bit rate, and the AP 1202 transmits triggers with a trigger pattern similar to the arrival time of the packets. At time T2, STA 1204 begins receiving packets at a lower encoder bit rate, and the AP 1202 continues to transmit triggers with the same triggering pattern, resulting in STA 1204 having not packets to transmit when a trigger is received at time T3. Prior to time T4, STA 1204 transmits timing information to AP 1202 (not shown), and AP 1204 decrease the frequency of triggering, resulting the trigger pattern better matching the lower encoder bit rate.

Although FIG. 12 illustrates one example trigger pattern change with encoding bit rate based on missed packets 1200, various changes may be made to FIG. 12. For example, various changes to the trigger pattern could be made, etc. according to particular needs.

In some embodiments, the STA can explicitly request a change to the triggering pattern by transmitting a change request message. In some embodiments, the change request message can contain at least one or more of the information items indicated in Table 4. In embodiments such as these, upon receiving the updated information, the AP changes the triggering pattern.

TABLE 4
Information items that can be present
in the change request message

| Information | |
|---|---|
| item | Description |
| Modified | One or more information item(s) that can convey a |
| bit rate | modified/new bit rate (e.g., a new data rate |
| | specified at the MAC SAP). |
| Modified | One or more information item(s) that can convey a |
| trigger | modified triggering interval (e.g., the new duration |
| interval | between two consecutive triggers). |
| Reason | One or more information item(s) that can convey a |
| information | reason information conveying a request to change |
| | the triggering pattern (e.g., a reason code conveying |
| | a higher triggering frequency/lower trigger frequency). |

In some embodiments, the STA and the AP can agree during the SCS setup phase that the AP can receive such dynamic modifications to the SCS agreement from the STA. For example, this can be performed by including an indication in the SCS request frame that can indicate this new type of agreement between the AP and the STA. In some embodiments, the indication can be in the form of one or more of the information items as indicated in Table 5. In embodiments such as these, upon receiving such a request from the STA, the AP can expect the STA to send dynamic modification requests to the AP. If the AP accepts such a request from the STA, then the request can convey to the STA that the AP can receive such modifications and put them into effect.

TABLE 5
Information items that can be present in the SCS request frame

| Information | |
|---|---|
| item | Description |
| Dynamic | One or more information item(s) that can indicate |
| modification | that the STA can transmit one or more parameters |
| indication | that can indicate a need for a modification in |
| | the triggering pattern from the AP (e.g., a flag/ |
| | bit that can make the indication, new information |
| | element that can carry the indication, etc.). |

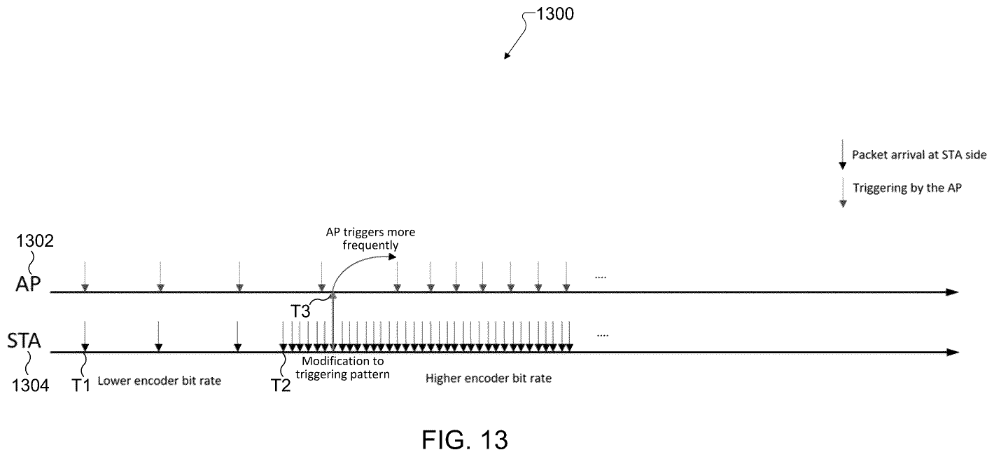

FIG. 13 illustrates an example of modification of trigger pattern by a STA 1300 according to embodiments of the present disclosure. The embodiment of modification of trigger pattern FIG. 13 is for illustration only. Different embodiments of modification of trigger pattern by a STA could be used without departing from the scope of this disclosure.

In the example of FIG. 13, at time T1, STA 1304 begins receiving packets at a lower encoder bit rate, and the AP 1302 transmits triggers with a trigger pattern similar to the arrival time of the packets. At time T2, STA 1304 begins receiving packets at a higher encoder bit rate, and the AP 1302 continues to transmit triggers with the same triggering pattern. At time T3, STA 1304 transmits a change request message to AP 1302, and AP 1302 increases the frequency of triggering in response to the change request message.

Although FIG. 13 illustrates one example of modification of trigger pattern by a STA 1300, various changes may be made to FIG. 13. For example, various changes to the trigger pattern could be made, etc. according to particular needs.

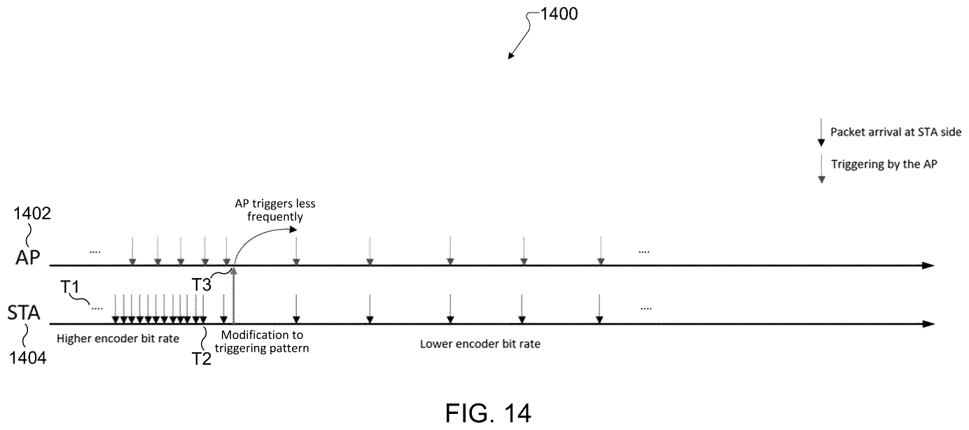

FIG. 14 illustrates another example of modification of trigger pattern by a STA 1400 according to embodiments of the present disclosure. The embodiment of modification of trigger pattern FIG. 14 is for illustration only. Different embodiments of modification of trigger pattern by a STA could be used without departing from the scope of this disclosure.

In the example of FIG. 14, at time T1, STA 1404 begins receiving packets at a higher encoder bit rate, and the AP 1402 transmits triggers with a trigger pattern similar to the arrival time of the packets. At time T2, STA 1404 begins receiving packets at a lower encoder bit rate, and the AP 1402 continues to transmit triggers with the same triggering pattern. At time T3, STA 1404 transmits a change request message to AP 1402, and AP 1402 decreases the frequency of triggering in response to the change request message.

Although FIG. 14 illustrates one example of modification of trigger pattern by a STA 1400, various changes may be made to FIG. 14. For example, various changes to the trigger pattern could be made, etc. according to particular needs.

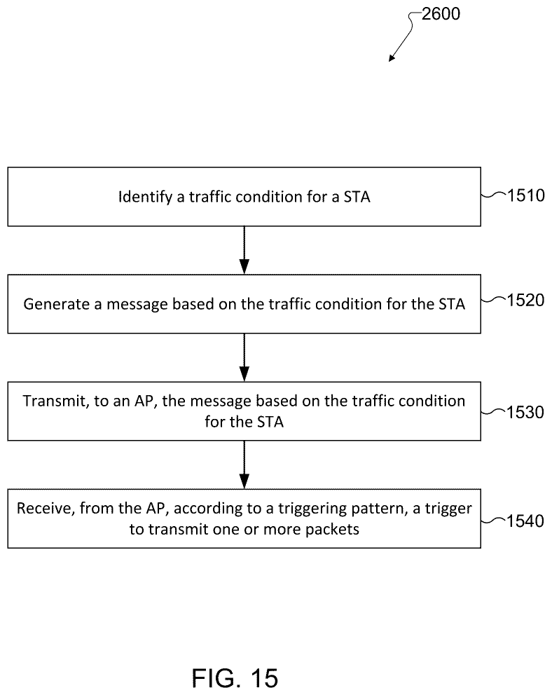

FIG. 15 illustrates an example method for enhancement for low latency support in next generation WLANs 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for overhead reduction for timing information sharing in next generation WLANs could be used without departing from the scope of this disclosure.

In the example of FIG. 15, method 1500 begins at step 1510. At step 1510, a STA (such as STA 904 of FIG. 9, or STA 1004 of FIG. 10) identifies a traffic condition for the STA.

In some embodiments, the STA may also (i) transmit, to the AP, an SCS request, the SCS request including an indication for enhanced SCS, and (ii) receive, from the AP, an SCS response, the SCS response including an indication of acceptance of enhanced SCS, similar as shown in FIG. 10. In embodiments such as these, the STA may identify the traffic condition for the STA after receipt of the SCS response.

In some embodiments, the STA may also (i) transmit, to the AP, an SCS request, the SCS request including a dynamic modification indication, and (ii) receive, from the AP, an SCS response, the SCS response including an indication of acceptance of dynamic modification. In embodiments such as these, the STA may identify the traffic condition for the STA after receipt of the SCS response.

At step 1520, the STA generates a message based on the traffic condition for the STA.

In some embodiments, the message generated based on the traffic condition for the STA may be a BSR.

In some embodiments, the message generated based on the traffic condition for the STA may include timing information for one or more enqueued packet. In some embodiments, the timing information may include one or more of a packet enqueue time, a packet expiration time, and an HOL delay.

In some embodiments, the message generated based on the traffic condition for the STA may be a change request message. In some embodiments, the contents of the change request message may include one or more of a modified bit rate, a modified trigger interval, and reason information.

At step 1530, the STA transmits, to an AP (such as AP 902 of FIG. 9, or AP 1002 of FIG. 10), the message based on the traffic condition for the STA.

At step 1540, the STA receives, according to a triggering pattern, a trigger to transmit one or more packets.

In some embodiments, where the message generated based on the traffic condition for the STA is a BSR, the triggering pattern may be adjusted by the AP based on contents of the BSR.

In some embodiments, where the message generated based on the traffic condition for the STA includes timing information for one or more enqueued packet, the triggering pattern may be adjusted by the AP based on the timing information.

In some embodiments, where the message generated based on the traffic condition for the STA is a change request message, the triggering pattern may be adjusted by the AP based on contents of the change request message.

Although FIG. 15 illustrates one example method for enhancement for low latency support in next generation WLANs 1500, various changes may be made to FIG. 15. For example, while shown as a series of steps, various steps in FIG. 15 could overlap, occur in parallel, occur in a different order, occur any number of times, be omitted, or replaced by other steps.

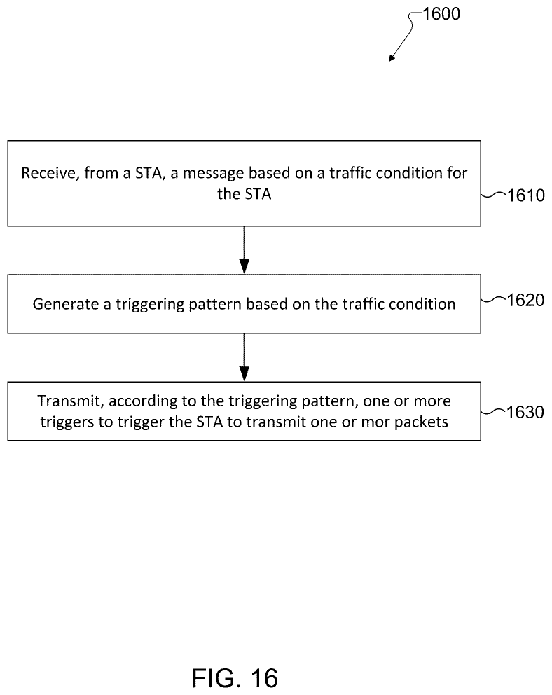

FIG. 16 illustrates another example method for enhancement for low latency support in next generation WLANs 1600 according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a method for overhead reduction for timing information sharing in next generation WLANs could be used without departing from the scope of this disclosure.

In the example of FIG. 16, method 1600 begins at step 1610. At step 1610, an AP (such as AP 902 of FIG. 9, or AP 1002 of FIG. 10) receives, from a STA (such as STA 904 of FIG. 9, or STA 1004 of FIG. 10), a message generated based on a traffic condition for the STA.

In some embodiments, the AP may also (i) receive, from the STA, an SCS request, the SCS request including an indication for enhanced SCS, and (ii) transmit, to the STA, and SCS response, the SCS response including an indication of acceptance of enhanced SCS similar as shown in FIG. 10. In embodiments such as these, the message generated based on the traffic condition for the STA may be received after transmission of the SCS response.

In some embodiments, the AP may also (i) receive, from the STA, an SCS request, the SCS request including a dynamic modification indication, and (ii) transmit, to the STA, and SCS response, the SCS response including an indication of acceptance of dynamic modification. In embodiments such as these, the message generated based on the traffic condition for the STA may be received after transmission of the SCS response.

In some embodiments, the message generated based on the traffic condition for the STA may be a BSR.

In some embodiments, the message generated based on the traffic condition for the STA may include timing information for one or more enqueued packet. In some embodiments, the timing information may include one or more of a packet enqueue time, a packet expiration time, and an HOL delay.

In some embodiments, the message generated based on the traffic condition for the STA may be a change request message. In some embodiments, the contents of the change request message may include one or more of a modified bit rate, a modified trigger interval, and reason information.

At step 1620, the AP adjusts a triggering pattern based on the message generated based on the traffic condition for the STA.

In some embodiments, where the message generated based on the traffic condition for the STA is a BSR, the triggering pattern may be adjusted by the AP based on contents of the BSR.

In some embodiments, where the message generated based on the traffic condition for the STA includes timing information for one or more enqueued packet, the triggering pattern may be adjusted by the AP based on the timing information.

In some embodiments, where the message generated based on the traffic condition for the STA is a change request message, the triggering pattern may be adjusted by the AP based on contents of the change request message.

At step 1630, the AP transmits, according to the triggering pattern, one or more triggers to trigger the STA to transmit one or more packets.

Although FIG. 16 illustrates one example method for enhancement for low latency support in next generation WLANs 1600, various changes may be made to FIG. 16. For example, while shown as a series of steps, various steps in FIG. 16 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor configured to:
identify a traffic condition for the STA; and
generate a message based on the traffic condition for the STA; and
a transceiver operably coupled to the processor, the transceiver configured to:
transmit, to an access point (AP), the message based on the traffic condition for the STA; and
receive, from the AP, according to a triggering pattern, a trigger to transmit one or more packets.

2. The STA of claim 1, wherein:
the transceiver is further configured to:
transmit, to the AP, a stream classification service (SCS) request, the SCS request including an indication for enhanced SCS; and
receive, from the AP, an SCS response, the SCS response including an indication of acceptance of enhanced SCS;
the processor is further configured to identify the traffic condition for the STA after receipt of the SCS response;
the message generated based on the traffic condition for the STA is a buffer status report (BSR); and
the triggering pattern is adjusted by the AP based on contents of the BSR.

3. The STA of claim 1, wherein:
the message generated based on the traffic condition for the STA includes timing information for one or more enqueued packet; and
the triggering pattern is adjusted by the AP based on the timing information.

4. The STA of claim 3, wherein the timing information includes one or more of:
a packet enqueue time;
a packet expiration time; and
a head of line (HOL) delay.

5. The STA of claim 1, wherein:
the message generated based on the traffic condition for the STA is a change request message; and
the triggering pattern is adjusted by the AP based on contents of the change request message.

6. The STA of claim 5, wherein the contents of the change request message include one or more of:
a modified bit rate;
a modified trigger interval; and
reason information.

7. The STA of claim 5, wherein:
the transceiver is further configured to:
transmit, to the AP, a stream classification service (SCS) request, the SCS request including a dynamic modification indication; and
receive, from the AP, an SCS response, the SCS response including an indication of acceptance of dynamic modification; and
the processor is further configured to identify the traffic condition for the STA after receipt of the SCS response.

8. An access point (AP) comprising:
a transceiver configured to receive, from a station (STA), a message generated based on a traffic condition for the STA; and
a processor operably coupled to the transceiver, the processor configured to:
adjust a triggering pattern based on the message generated based on the traffic condition for the STA; and
cause the transceiver to transmit, according to the triggering pattern, one or more triggers to trigger the STA to transmit one or more packets.

9. The AP of claim 8, wherein:
the transceiver is further configured to:
receive, from the STA, a stream classification service (SCS) request, the SCS request including an indication for enhanced SCS; and
transmit, to the STA, an SCS response, the SCS response including an indication of acceptance of enhanced SCS;
the message generated based on the traffic condition for the STA is received after transmission of the SCS response;
the message generated based on the traffic condition for the STA is a buffer status report (BSR); and
the processor is further configured to adjust the triggering pattern based on contents of the BSR.

10. The AP of claim 8, wherein:
the message generated based on the traffic condition for the STA includes timing information for one or more enqueued packet; and
the processor is further configured to adjust the triggering pattern based on the timing information.

11. The AP of claim 10, wherein the timing information includes one or more of:
a packet enqueue time;
a packet expiration time; and
a head of line (HOL) delay.

12. The AP of claim 8, wherein:
the message generated based on the traffic condition for the STA is a change request message; and
the processor is further configured to adjust the triggering pattern based on contents of the change request message.

13. The AP of claim 12, wherein the contents of the change request message include one or more of:
a modified bit rate;
a modified trigger interval; and
reason information.

14. The AP of claim 12, wherein:
the transceiver is further configured to:
receive, from the STA, a stream classification service (SCS) request, the SCS request including a dynamic modification indication; and
transmit, to the STA, an SCS response, the SCS response including an indication of acceptance of dynamic modification; and
the message generated based on the traffic condition for the STA is received after transmission of the SCS response.

15. A method of operating a station (STA), the method comprising:
identifying a traffic condition for the STA;
generating a message based on the traffic condition for the STA;
transmitting, to an access point (AP), the message based on the traffic condition for the STA; and
receiving, from the AP, according to a triggering pattern, a trigger to transmit one or more packets.

16. The method of claim 15, further comprising:
transmitting, to the AP, a stream classification service (SCS) request, the SCS request including an indication for enhanced SCS; and
receiving, from the AP, an SCS response, the SCS response including an indication of acceptance of enhanced SCS,
wherein:
the traffic condition for the STA is identified after receipt of the SCS response;
the message generated based on the traffic condition for the STA is a buffer status report (BSR); and
the triggering pattern is adjusted by the AP based on contents of the BSR.

17. The method of claim 15, wherein:
the message generated based on the traffic condition for the STA includes timing information for one or more enqueued packet; and
the triggering pattern is adjusted by the AP based on the timing information.

18. The method of claim 17, wherein the timing information includes one or more of:
a packet enqueue time;
a packet expiration time; and
a head of line (HOL) delay.

19. The method of claim 15, wherein:
the message generated based on the traffic condition for the STA is a change request message;
the triggering pattern is adjusted by the AP based on contents of the change request message; and
the contents of the change request message include one or more of:
a modified bit rate;
a modified trigger interval; and
reason information.

20. The method of claim 19, further comprising:
transmitting, to the AP, a stream classification service (SCS) request, the SCS request including a dynamic modification indication; and
receiving, from the AP, an SCS response, the SCS response including an indication of acceptance of dynamic modification,
wherein the traffic condition for the STA is identified after receipt of the SCS response.
